(19) United States
(12) Patent Application Publication
(10) Pub. No.: US 2025/0362235 A1
(43) Pub. Date: Nov. 27, 2025

(54) COMPACT CALIBRATED INTERFEROMETRIC CHARACTERISATION SYSTEM

(71) Applicants: ARYBALLE, Grenoble (FR); UNIVERSITE GRENOBLE ALPES, Saint Martin D'heres (FR); INSTITUT NATIONAL POLYTECHNIQUE GRENOBLE, GRENOBLE (FR)

(72) Inventors: Florent CHATELAIN, SAINT MARTIN D'HERES Cedex (FR); Simon BARTHELME, SAINT MARTIN D'HERES Cedex (FR); Clément CASCALES, SAINT MARTIN D'HERES Cedex (FR); Pierre MAHO, GRENOBLE (FR); Van tri NGUYEN, GRENOBLE (FR); Delphine DESCLOUX, FR (FR); Cyril HERRIER, GRENOBLE (FR); Thierry LIVACHE, GRENOBLE (FR)

(21) Appl. No.: 19/109,005

(22) PCT Filed: Sep. 1, 2023
(86) PCT No.: PCT/EP2023/074052

§ 371 Date: Apr. 30, 2025

(30) Foreign Application Priority Data
Sep. 5, 2022 (FR) FR2208858

(51) Int. Cl. G01N 21/77; G01N 21/27

(52) U.S. Cl. CPC G01N 21/7703; G01N 21/274; G01N 2021/7779

(57) ABSTRACT

An interferometry system for characterizing analytes present in a fluid medium, the system comprising: at least one light source suitable for emitting an optical signal having predefined power; an array of photodetectors; an array of N Mach-Zehnder interferometers each comprising an input divider coupled to the light source, two waveguides forming a sensitive arm and a reference arm, and a multimode output coupler having a plurality of outputs, only two of which, referred to as useful outputs, phase shifted by π/2, are coupled to the photodetectors; and a processing unit comprising, for each of the Mach-Zehnder interferometers, predetermined calibration parameter values which are formed of: the input power Pⱼₙ₍ₙ₎ of the optical signal incident on an input divider according to the predefined power of the optical signal emitted by the light source; and optical power offsets O₁₍ₙ₎.

### TECHNICAL FIELD

The field of the invention is the characterization, by an interferometry system, of analytes present in a gas or liquid medium.

### PRIOR ART

The ability to analyze and characterize analytes present in a fluid medium, such as for example odorous molecules or volatile organic compounds, or even compounds present in solution or suspension in a liquid medium, is an increasingly important issue, especially in the fields of health, the food industry, the perfume industry (scents), and even the industry of olfactory comfort in confined public or private spaces (cars, hotels, common areas, etc.). The characterization of such analytes present can be carried out by a characterization system.

Various characterization approaches are available, which differ from one another especially by whether or not the analytes or receptors need to be “tagged” with a reagent beforehand. Unlike fluorescence detection, for example, which requires the use of such markers, detection using surface plasmon resonance imaging (SPRi) and detection using interferometry, such as the Mach-Zehnder Interferometer (MZI), are so-called label-free techniques.

In such a characterization system, the analytes present in a fluid medium interact by adsorption/desorption with receptors located in one or more sensitive sites on a functionalized surface. The aim is to detect in real time an optical signal associated with each of the sensitive sites, representative of the time variation in the local refractive index due to the adsorption/desorption interactions of the analytes with the receptors. The intensity or power of each optical signal detected by an optical sensor is directly correlated to the adsorption/desorption interactions of the analytes with the receptors.

FIG. 1A exemplifies a Mach-Zehnder interferometer 12 in a characterization system, as described in document EP3754326A1. This characterization system comprises a functionalized surface in which the receptors are located, a measurement device consisting of a light source (a diffraction grating herein provides the coupling between the light source and the interferometer 12), an array of Mach-Zehnder interferometers 12 in a photonic integrated circuit (ΦIC) of a photonic chip, and photodetectors (a diffraction grating herein provides the coupling with a remote photodetector), and a processing unit (also not shown). Each interferometer 12 comprises two waveguides, one of which forms a reference arm 14r, and the other a sensitive arm 14s, the receptors being located on the surface thereof. The presence of analytes adsorbed on the surface of the sensitive arm 14s modifies the properties of the optical signal passing through it, and more specifically leads to a change in the phase of the optical signal, whereas the phase of the optical signal passing through the reference arm 14r remains unchanged. The phase difference Φ(t) between these optical signals leads to constructive or destructive interference, which modulates the power of the optical output signal detected by the photodetector.

FIG. 1B exemplifies a signal (or sensorgram) obtained by a characterization system during an analyte characterization process. A sensorgram herein is a signal corresponding to the time evolution of the phase shift Φ(t), during a reference phase Ph_{ref} wherein the analytes are not present, followed by a characterization phase Ph_{carac} wherein the analytes are present and interact with the receptors. The analytes can then be characterized from the values ∠ᵢ and Φ_{f} of the phase shift Φ(t) associated with the reference phase Ph_{ref} and the characterization phase Ph_{carac}, respectively

However, sin ce the power of the optical signal received by the photodetector is a sinusoidal function of the phase shift Φ(t), it may be necessary to be able to determine the direction of variation of the phase shift Φ(t). For this purpose, in one approach, the Mach-Zehnder interferometer comprises a 2×3 multimode output coupler (MMI for MultiMode Interferometer). The multimode coupler therefore comprises three outputs, phase-shifted by 2π/3, which are referred to as useful outputs because they are each coupled to a photodetector. FIG. 1C exemplifies such a Mach-Zehnder interferometer 12, described in the document by Halir et al. Direct and Sensitive Phase Readout for Integrated Waveguide Sensors, IEEE Photonics J., Vol.5, No.4, 6800906, August 2013, comprising a multimode coupler 15 coupled to three photodetectors 16. Also, for an array of N Mach-Zehnder interferometers 12, it is necessary to provide an array of 3×N photodetectors 16, which translates into a significant footprint on the surface of the photonic chip. This footprint may be due to the presence on the photonic chip of an array of 3×N diffraction gratings to provide coupling with a remote array photodetector (camera), or to the presence of the array of 3×N photodetectors when they are integrated into the photonic chip.

Characterization systems using Mach-Zehnder interferometers are described especially in the paper by Laplatine et al. entitled Silicon photonic olfactory sensor based on an array of 64 biofunctionalized Mach-Zehnder interferometers, Optics Express, Vol. 30, No. 19, pages 33955-33968, 2022, in the paper by Milvich et al. entitled Integrated phase-sensitive photonic sensors: a System design tutorial, Advances in Optics and Photonics, Vol. 13, No. 3, pages 584-642, 2021, and in the paper by Schweikert et al. entitled Improved Phase Detection in On-Chip Refractometers, 2021 International Conference on Numerical Simulation of Optoelectronic Devices (NUSOD), pages 113-114, 2021.

### DISCLOSURE OF THE INVENTION

The aim of the invention is to remedy, at least in part, the disadvantages of the background art, and more particularly to offer a characterization system, of the interferometric type, having a reduced footprint, while still being able to determine the phase shift Φ(t) and its direction of variation.

For this purpose, the subject matter of the invention is a characterization system suitable for characterizing analytes present in a fluid medium, comprising a measurement device which comprises:
at least one light source, suitable for emitting an optical signal having predefined power;
an array of N Mach-Zehnder interferometers, with N>1, each comprising: an input divider coupled to the light source; two waveguides forming a sensitive arm, on the surface of which are located receptors with which the analytes are able to interact by adsorption/desorption, and a reference arm; and a multimode output coupler, coupled to the two waveguides;
an array of photodetectors, suitable for measuring the power of the optical signals transmitted by the multimode couplers.

The characterization system also comprises a processing unit, suitable for determining, for each Mach-Zehnder interferometer of index n ranging from 1 to N: a phase shift Φ₍ₙ₎(t) between the optical signals circulating in the waveguides, from the measured powers; values Φᵢ₍ₙ₎ and Φ_{f(n)}, from the phase shift Φ₍ₙ₎(t), associated with a reference phase in which the analytes are not present and a characterization phase in which the analytes are present and interact with the receptors, respectively; and then for characterizing the analytes, from the values Φᵢ₍ₙ₎ and Φ_{f(n)}.

According to the invention, each of the multimode couplers has a plurality of outputs, only two of which, referred to as useful outputs, phase-shifted by π/2, are coupled to the photodetectors. In addition, the photodetectors form an array of 2×N photodetectors, each measuring the powers P₁₍ₙ₎(t) and P₂₍ₙ₎(t) of the optical signals transmitted by the useful outputs of each Mach-Zehnder interferometer.

In addition, the processing unit comprises, for each of the Mach-Zehnder interferometers, predetermined values of calibration parameters consisting of: an input power Pᵢₙ₍ₙ₎ of the optical signal incident on the input divider, according to the predefined power of the optical signal emitted by the light source; and optical power offsets P₍ₙ₎, P₂₍ₙ₎ associated with each useful output and defined when the light source is inactive. In addition, it is suitable for determining the phase shift Φ₍ₙ₎ (t) from the optical powers P₁₍ₙ₎(t) and P₂₍ₙ₎(t) measured and associated with the useful outputs, and predetermined values of the calibration parameters Pᵢₙ₍ₙ₎, o₁₍ₙ₎, and o₂₍ₙ₎.

Some preferred but non-limiting aspects of this characterization system are as follows.

Each output coupler can comprise outputs that are not coupled to the photodetector array, referred to as “non-useful” outputs, comprising tapered ends.

The characterization system can comprise a photonic chip containing: the array of N Mach-Zehnder interferometers; as well as an array of 2×N optical detection elements coupled to the N interferometers by integrated waveguides, the optical detection elements being either said photodetectors or diffraction gratings coupled to an array photodetector.

The measurement device may comprise an array of at least four Mach-Zehnder interferometers.

Each multimode coupler can be a 2×4 coupler.

The characterization system can comprise a calibration device suitable for determining, together with the processing unit, the values of the calibration parameters Pᵢₙ₍ₙ₎, o₁₍ₙ₎, and o₂₍ₙ₎.

The calibration device can comprise a reservoir of so-called calibration analytes, fluidically connected to the measurement device to allow the calibration analytes to interact with the receptors, having a predefined concentration of calibration analytes to induce, when interacting with the receptors, a predefined minimum variation ΔΦₘᵢₙ in the phase shift Φ₍ₙ₎(t) of each of the Mach-Zehnder interferometers.

The calibration device can comprise a Mach-Zehnder interferometer, referred to as calibration interferometer, coupled to at least one so-called calibration photodetector.

The calibration interferometer can comprise a reference arm and a discontinuous arm.

The invention also relates to a process for calibrating a characterization system according to an embodiment in which the calibration device comprises a reservoir of calibration analytes. The process then comprises the following steps:
activating the light source to emit the optical signal at the predefined power;
placing the calibration analytes in contact with the receptors;
measuring, by means of the photodetectors, a power P₁₍ₙ₎(t), P₂₍ₙ₎(t) of the optical signals transmitted by each Mach-Zehnder interferometer, while the calibration analytes interact with the receptors and induce a variation of the phase shift Φ₍ₙ₎(t) that is at least equal to the predefined minimum value ΔΦₘᵢₙ;
determining, by means of the processing unit, the values of the calibration parameters Pᵢₙ₍ₙ₎, o₁₍ₙ₎, and o₂₍ₙ₎ from the measured powers P₁₍ₙ₎(t), P₂₍ₙ₎(t), and storing the determined values of the calibration parameters Pᵢₙ₍ₙ₎, o₁₍ₙ₎, and o₂₍ₙ₎ in the processing unit.

The calibration parameters Pᵢₙ₍ₙ₎, o₁₍ₙ₎, and o₂₍ₙ₎ can be determined from the minimum and maximum values of the measured powers P₁₍ₙ₎(t), P₂₍ₙ₎(t).

The invention also relates to a process for calibrating a characterization system according to an embodiment in which the calibration device comprises a calibration interferometer and at least one calibration photodetector. The process then comprises the following steps:
measuring, by means of the calibration photodetector, the power of the optical signal transmitted by the calibration interferometer, while the light source is activated;
determining a value for the input power P_{in,calib} of the optical signal incident on an input divider of the calibration interferometer; then
determining the input value Pᵢₙ₍ₙ₎ for each of the interferometers in the measurement device, from the value P_{in,calib} determined.

The process may comprise the following steps: measuring a power P₁₍ₙ₎(t), P₂₍ₙ₎(t) of the optical signals transmitted by each interferometer of the measurement device, by means of the photodetectors of the measurement device, while the light source is inactive; then determining the values of the offsets o₁₍ₙ₎ and o₂₍ₙ₎ from the measured powers P₁₍ₙ₎(t), P₂₍ₙ₎(t).

The invention also relates to a process for characterizing analytes by means of a characterization system according to any one of the preceding features, comprising the following steps:
measuring, by means of the photodetectors of the measurement device, a power P₁₍ₙ₎(t), P₂₍ₙ₎(t) of the optical signals transmitted by each Mach-Zehnder interferometer, during a reference phase in which the analytes are not present, and during a characterization phase in which the analytes are present and interact with the receptors;
determining, by means of the processing unit, for each Mach-Zehnder interferometer, the phase shift Φ₍ₙ₎(t) between the optical signals circulating in the arms, from the measured powers P₁₍ₙ₎(t), P₂₍ₙ₎(t) and the predetermined values of the calibration parameters Pᵢₙ(n), o₁₍ₙ₎, and o₂₍ₙ₎;
determining values Φᵢ₍ₙ₎ and Φ_{f(n)} from the phase shift Φ₍ₙ₎(t), associated with the reference phase and the characterization phase, respectively;
characterizing the analytes from the values Φᵢ₍ₙ₎ and Φ_{f(n)}.

The step of determining the phase shift Φ₍ₙ₎(t) can consist in determining: a phase shift Φ₍ₙ₎(t), referred to as extracted phase shift, the values of which is between 0 and 2π, from the measured powers P₁₍ₙ₎(t), P₂₍ₙ₎(t) and the predetermined values of the calibration parameters Pᵢₙ₍ₙ₎, o₁₍ₙ₎, and o₂₍ₙ₎; then the phase shift Φ₍ₙ₎(t), referred to as the unfolded phase shift, by unfolding the extracted phase shift Φ₍ₙ₎(t) by adding a positive or negative integer multiple of 2π thereto.

### BRIEF DESCRIPTION OF THE DRAWINGS

Other aspects, purposes, advantages and features of the invention will become clearer from the following detailed description of preferred embodiments thereof, given by way of non-limiting example, and made with reference to the appended drawings, in which:

FIG. 1A, already described, is a schematic and partial perspective view of a Mach-Zehnder interferometer of a characterization system according to an example of the background art;

FIG. 1B, already described, exemplifies the time evolution of a phase shift Φ(t) between the optical signals circulating in the two waveguides of a Mach-Zehnder interferometer, during a reference phase Ph_{ref} and then a characterization phase Ph_{carac};

FIG. 1C, already described, is a schematic and partial view of a Mach-Zehnder interferometer of a characterization system according to another example of the background art, which comprises a 2×3 multimode output coupler;

FIG. 2A is a schematic and partial view of a compact calibrated characterization system, according to one embodiment;

FIG. 2B is a schematic and partial view of another example of a Mach-Zehnder interferometer of the measurement device of the calibrated characterization system according to one embodiment;

FIG. 3A exemplifies the time evolutions of the extracted phase shift Φ(t) and the unfolded phase shift Φ(t) associated with the optical signals circulating in the arms of a Mach-Zehnder interferometer of FIG. 2A or FIG. 2B, highlighting the unfolding of the phase;

FIG. 3B exemplifies a flow chart of a calibration process and an analyte characterization process according to one embodiment;

FIG. 4A is a schematic and partial view of a compact characterization system, to be calibrated, in which the calibration device comprises a reservoir of calibration analytes;

FIG. 4B is a schematic and partial view of the characterization system to be calibrated of FIG. 4A, exemplifying the fluidic connections between the reservoir of calibration analytes and the measurement device of the characterization system;

FIG. 5A exemplifies the time evolution of the power P₁₍ₙ₎(t) and P_{2 (n)}(t) of optical signals transmitted by the multimode coupler of a Mach-Zehnder interferometer of a characterization system according to one embodiment, in order to determine the calibration parameters Pᵢₙ₍ₙ₎, o₁₍ₙ₎, and o₂₍ₙ₎;

FIG. 5B further exemplifies the time evolution of the extracted phase shift Φ₍ₙ₎(t), herein in the form of an ellipse in a complex plane (x, y), also with a view to determining the calibration parameters Piₙ₍ₙ₎, o₁₍ₙ₎, and o₂₍ₙ₎;

FIG. 6A is a schematic and partial view of a compact characterization system, to be calibrated, according to another embodiment in which the calibration device comprises a calibration Mach-Zehnder interferometer coupled to a calibration photodetector;

FIG. 6B is a schematic and partial view of another example of a calibration Mach-Zehnder interferometer.

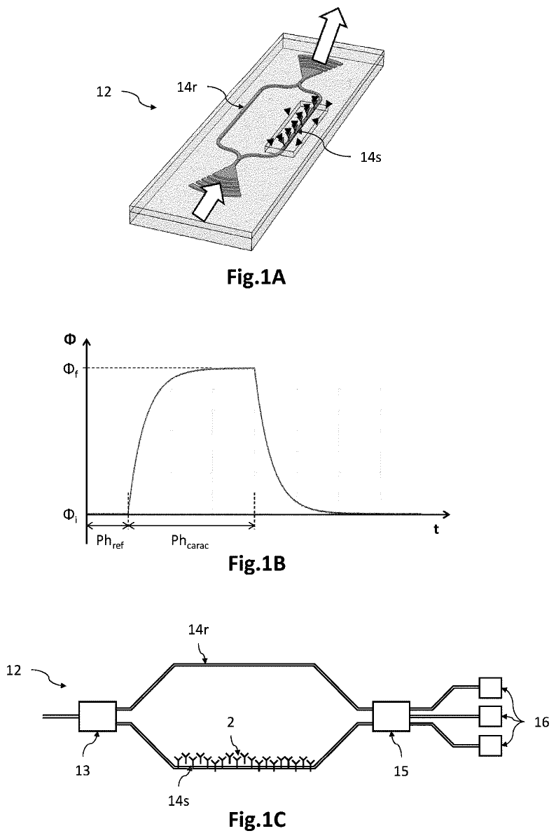

### DETAILED DESCRIPTION OF EMBODIMENTS

In the figures and in the rest of the description, the same references represent identical or similar elements. In addition, the various elements are not shown to scale, for the sake of clarity. Furthermore, the various embodiments and variants are not mutually exclusive and can be combined with one another. Unless otherwise indicated, the terms “substantially”, “approximately”, “of the order of” mean to within 10%, and preferably to within 5%. Furthermore, the words “between . . . and . . . ” and equivalents mean that bounds are included, unless otherwise stated.

The invention relates generally to the characterization of analytes present in a fluid medium (gas or liquid). Generally, characterization refers to obtaining information representative of the interactions of the analytes contained in the fluid medium with the receptors at sensitive sites on a functionalized surface of the characterization system. The interactions in question herein are adsorption and/or desorption events of the analytes with the receptors. This information also forms an interaction pattern, or analyte “signature”, which can be depicted, for example, as a histogram or radar diagram. More precisely, in the case where the characterization system comprises N discrete sensitive sites, the interaction pattern consists of the N representative items of scalar or vector information.

The invention relates more precisely to a calibrated characterization system, that is, a system in which the processing unit contains predetermined values of calibration parameters, for each of the Mach-Zehnder interferometers of a measurement device, these values thus enabling it to determine the phase shift Φ₍ₙ₎(t) between the optical signals circulating in the arms of each Mach-Zehnder interferometer as well as its direction of variation. The invention also relates to a characterization system to be calibrated, thus comprising a calibration device for determining, with the processing unit, these values of the calibration parameters. It finally relates to a process for calibrating such a characterization system (to be calibrated), and a process for characterizing analytes using such a calibrated characterization system.

It is noted herein that, for each Mach-Zehnder interferometer with index n ranging from 1 to N, with N>1, the calibration parameters consist of: an input power Pᵢₙ₍ₙ₎ of the optical signal incident on the input divider, according to the predefined power of the optical signal emitted by the light source of the characterization system; and optical power offsets o₁₍ₙ₎, o₂₍ₙ₎ associated with each useful output and defined when the light source is inactive (and therefore the input power of the optical signal incident on the input divider is zero). The term “offset” is synonymous with bias, offset, offset error, zero error, etc.

Analyte characterization is carried out by means of an interferometric characterization system comprising at least:
a measurement device comprising:
at least one light source suitable for emitting an optical signal having predefined power;
an array of N Mach-Zehnder interferometers, with N>1, each comprising: an input divider coupled to the light source; two waveguides which form a sensitive arm and a reference arm; and an MMI-type output coupler (multimode coupler) having a plurality of outputs, of which only two useful outputs are phase-shifted by π/2;
an array of 2×N photodetectors coupled to the useful outputs, either directly (the photodetectors are then arranged on or in the photonic chip) or indirectly (via an array of 2×N diffraction gratings made on or in the photonic chip);
a processing unit:
comprising predetermined values of the calibration parameters for each of the Mach-Zehnder interferometers of the measurement device;
suitable for determining, for each of said interferometers, a phase shift Φ₍ₙ₎(t) between the optical signals circulating in the arms, from the measured optical powers P₁₍ₙ₎(t) and P₂₍ₙ₎(t) associated with the useful outputs, and from the predetermined values of the calibration parameters (input power Pᵢₙ₍ₙ₎ and offsets o₁₍ₙ₎, o₂₍ₙ₎; then
suitable for characterizing the analytes from values Φᵢ₍ₙ₎ and Φ_{f(n)} of the phase shift Φ₍ₙ₎(t) associated with a reference step Ph_{ref} in which the interferometers are not exposed to the analytes, and a characterization step Ph_{carac} in which they are exposed to the analytes, respectively.

According to the invention, the output coupler of each Mach-Zehnder interferometer is a multimode coupler having two inputs coupled to the arms and a plurality of outputs (preferably four outputs). Of these outputs, only two, phase-shifted by π/2, are coupled to the photodetectors and are therefore said to be useful. The other outputs are not used to characterize the analytes (no coupling to the photodetectors of the measurement device). This configuration therefore greatly reduces the footprint on the photonic chip, insofar as only 2×N photodetectors are required, rather than 3×N as in the previously mentioned 2013 paper by Halir et al. The footprint associated with the waveguides connecting the output couplers to the photodetectors (when they are integrated in the photonic chip) or to the diffraction gratings (when the photodetectors are remote) is also greatly reduced. In addition, the predetermined values of the calibration parameters make it possible to determine the phase shift Φ₍ₙ₎(t) while being able to know its direction of variation.

As detailed hereunder, the characterization system can further comprise a calibration device suitable for determining, with the processing unit, during a calibration process, the values in question of the calibration parameters.

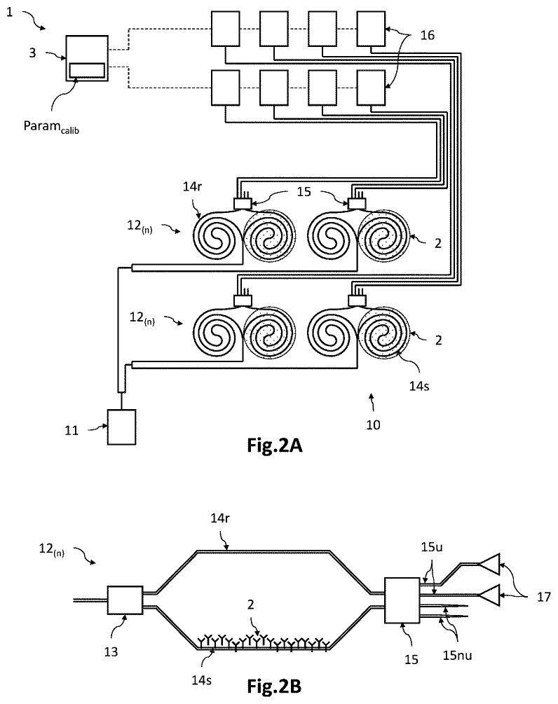

FIG. 2A is a schematic and partial view of a calibrated characterization system 1, according to one embodiment. FIG. 2B further exemplifies in greater detail the Mach-Zehnder interferometer 12₍ₙ₎ of the characterization system 1 of FIG. 2A.

Generally, the characterization system 1 comprises a measurement device 10, and a processing unit 3 containing predetermined values of calibration parameters Param_{calib}. The characterization system 1 is then said to be calibrated. The Mach-Zehnder interferometers 12₍ₙ₎ of the measurement device 10 are integrated in a photonic chip, which may be of the silicon photonic chip type.

The analytes are elements present in the fluid medium (gas or liquid) to be analyzed, and are intended to be detected and characterized by the characterization system 1. Examples include bacteria, viruses, proteins, lipids, volatile organic molecules, and inorganic compounds. Furthermore, the receptors 2 (ligands) are elements that cover one of the waveguides of the Mach-Zehnder interferometer 12 (sensitive arm 14s) and have the ability to interact with the analytes, although the chemical and/or physical affinities between the analytes and the receptors 2 are not necessarily known. The receptors 2 on the different sensitive surfaces preferably have different physicochemical properties, which impact their ability to interact with the analytes. Examples include amino acids, peptides, nucleotides, polypeptides, proteins, organic polymers, and oligo-or polysaccharides, among others.

The Mach-Zehnder interferometers 12₍ₙ₎ are produced in a photonic chip containing an integrated photonic circuit, for example silicon-based. The light source 11 and photodetectors 16 can be located on or in the photonic chip, or can be offset and coupled to it by optical couplers (diffraction gratings 17 etc.) as exemplified in FIG. 2B. Similarly, the processing unit 3 can be located in or on the photonic chip, or can be remote.

The measurement device 10 comprises at least one light source 11, an array of N Mach-Zehnder interferometers 12₍ₙ₎, and an array of 2×N photodetectors 16.

The light source 11 is preferably an optical source of coherent or non-coherent light, with a continuous or pulsed, monochromatic signal, reduced spectral width (e.g. less than 30 nm, or even 15 nm, or even 2 nm or even 1 nm) and a predefined central wavelength, for example in the near infrared. It can be a Vertical Cavity Surface Emitting Laser (VCSEL) source, a III-V/Si hybrid laser source, a laser diode, or any other type of laser source. It can also be a light-emitting diode.

The measurement device 10 of the characterization system 1 comprises an array of N Mach-Zehnder interferometers 12₍ₙ₎, with N>1, preferably at least 4, for example 64 or even more, referenced by the index n ranging from 1 to N. The interferometers 12₍ₙ₎ each comprise an input divider 13 (for example of the MMI type), two waveguides 14r, 14s coupled to the input divider 13, one of which forms a sensitive arm 14s sensitive to the amount of analytes adsorbed to the receptors 2, and the other of which forms a reference arm 14r not sensitive to the analytes present, so that the optical signals circulating in the two arms 14r, 14s have an effective phase shift, denoted Φ(t). The two waveguides 14r, 14s are then coupled to a multimode coupler 15 having a plurality of outputs phase-shifted by π/2 (herein four outputs), of which only two outputs phase-shifted by π/2 are useful and coupled to the photodetectors 16.

In the example shown in FIG. 2A, the arms 14r, 14s extend spirally in the sense that they wrap around themselves between the input divider 13 and the multimode coupler 15. They can also extend in a coiling fashion, or even in a straight line as exemplified in FIG. 2B (optionally with a coil and/or spiral section). Other shapes of waveguides are also possible.

The receptors 2 thus form N sensitive sites of a so-called functionalized surface of the photonic chip, this functionalized surface being intended to be exposed to the fluid medium containing the analytes. In other words, the sensitive sites are zones containing the receptors 2 and located at the sensitive arms 14s of the interferometers 12₍ₙ₎. They may comprise different receptors 2 from one sensitive site to the other in terms of physicochemical affinity with the analytes. A plurality of sensitive sites can be identical, in order, for example, to detect any measurement drift.

The interferometers 12₍ₙ₎ each comprise a sensitive arm 14s on the surface of which receptors 2 are arranged to form a sensitive site, the other arm comprising no receptors 2 and forming the reference arm 14r. The waveguide of the sensitive arm 14s (material having high refractive index) is located at a depth from the receptors 2 such that the optical signal propagating therein (guided mode) has an effective index which depends on the amount of analytes bound to the receptors 2 of the sensitive site. A notch (see, for example, patent application FR2106153 filed on Jun. 10, 2021) can thus be made in the sheath covering the sensitive arm 14s, so as to allow the guided mode to be influenced by the presence of the adsorbed analytes.

It should be noted that the effective index of a guided mode is defined as the product of the propagation constant β and of λ/2π, λ being the wavelength of the optical signal. The propagation constant β depends on the wavelength A and the mode of the optical signal, as well as the properties of the waveguide (refractive indices and geometry). The effective index of the mode corresponds, in a way, to the refractive index of the waveguide “seen” by the optical mode. It is usually between the index of the core and the index of the sheath of the waveguide. It is therefore understood that the amount of analytes adsorbed on the sensitive site modifies the properties of the optical mode and/or of the waveguide, especially the phase of the guided mode.

As a result, the presence of adsorbed analytes on the sensitive site of the sensitive arm 14s leads to a change in the phase of the guided mode, whereas the phase of the guided mode passing through the reference arm 14r remains substantially unchanged. The phase shift Φ(t) between the optical signals passing through the arms and then received by the multimode coupler 15 results in a change in the power of the optical signal recombined and detected by the photodetectors 16, due to constructive or destructive interference between the optical signals circulating in the two arms.

The output coupler 15 is, in this example, a 2×4 multimode coupler (MMI), but the number of inputs can be different. It comprises herein at least two outputs, referred to as useful outputs 15u, phase-shifted by π/2, and each coupled to a photodetector 16. The other outputs 15nu are referred to as non-useful outputs, insofar as they are not coupled to the photodetectors 16. These can each comprise a tapered end, so as to cause the optical signal to leak into the substrate of the photonic chip and to greatly reduce retroreflection towards the multimode coupler 15.

The measurement comprises an array of 2×N photodetectors 16, where each photodetector 16 is coupled to a useful output 15u of a multimode coupler 15 of an interferometer 12₍ₙ₎. The photodetectors 16 measure the value of the power (or the intensity, in an equivalent manner) of the optical signal transmitted by each useful output 15u, at each measurement instant, and transmit this information to the processing unit 3. The power of the optical signals at the useful outputs 15u is denoted P₁₍ₙ₎ and P₂₍ₙ₎. On the photonic chip, the array of interferometers 12 is coupled to an array of 2×N detection elements, which can be either diffraction gratings 17 when the photodetectors are remote from the photonic chip (in the form of a camera with 2×N sensitive detection zones, each sensitive zone optionally comprising at least one detection pixel), or the photodetectors 16 themselves when they are integrated into the photonic chip.

The processing unit 3 enables the processing operations of the analyte characterization process to be carried out. For this purpose, it is coupled to the photodetectors 16 of the measurement device 10. It comprises at least one microprocessor and at least one memory. It thus comprises a programmable processor capable of executing instructions stored on an information storage medium. It further comprises at least one memory containing the instructions required to carry out the characterization process. The memory is also suitable for storing the information calculated at each measurement instant.

In particular, the processing unit 3 contains the predetermined values of the calibration parameters Param_{calib}, for each of the interferometers 12₍ₙ₎ of the measurement device 10, namely more precisely the power Pᵢₙ₍ₙ₎ and the offsets o₁₍ₙ₎ and o₂₍ₙ₎. The power Pᵢₙ₍ₙ₎ is a function of the predefined power of the optical signal emitted by the light source 11: indeed, the value Pᵢₙ₍ₙ₎ depends on the higher or lower power of the signal emitted by the light source 11. Furthermore, the offsets associated the are with interferometers 12₍ₙ₎ and/or the photodetectors of the measurement device 10, and may result from the residual light present in the characterization system 1, or may even be related to the dark current of the photodetectors 16.

The processing unit 3 is suitable for determining an “extracted” phase shift Φ₍ₙ₎(t) representative of the phase shift between the optical signals circulating in the arms of each interferometer 12₍ₙ₎, from the optical powers P₁₍ₙ₎(t) and P₂₍ₙ₎(t) measured by the photodetectors 16 for each of the interferometers 12₍ₙ₎, and predetermined values of the calibration parameters Param_{calib}. It is also suitable for “unfolding the phase” in order to obtain the so-called “unfolded” phase shift Φ₍ₙ₎(t), and then for determining values Φᵢ₍ₙ₎ and Φᵢ₍ₙ₎ associated with the reference phase Ph_{ref} (absence of analytes) and the characterization phase Ph_{carac} (presence of analytes), respectively. These values Φᵢ₍ₙ₎ and Φ_{f(n)} make it possible to determine the signature of the analytes, such as, for example: S={Φ_{f(n)}−Φᵢ₍ₙ₎}_{n=1; N}.

As exemplified in FIG. 2A, the characterization system 1 has a small footprint on the photonic chip, insofar as the detection array only comprises 2×N detection elements (diffraction gratings 17 or photodetectors 16). The footprint associated with the waveguides that provide the coupling between the multimode couplers 15 and the detection array is also reduced. In the case of a remote camera, it has a reduced number 2×N of sensitive detection surfaces, enabling the use of a less expensive camera. In addition, by virtue of determining the calibration parameters Param_{calib} via the calibration device 20, the processing unit 3 is able to determine the phase shift Φ₍ₙ₎(t) while knowing the direction of its variation. Finally, it can be shown that the error in determining the phase shift Φ₍ₙ₎(t) can be smaller in the case of Mach-Zehnder interferometers 12₍ₙ₎ with two useful outputs 15u phase-shifted by π/2 than in the case of three useful outputs phase-shifted by 2π/3.

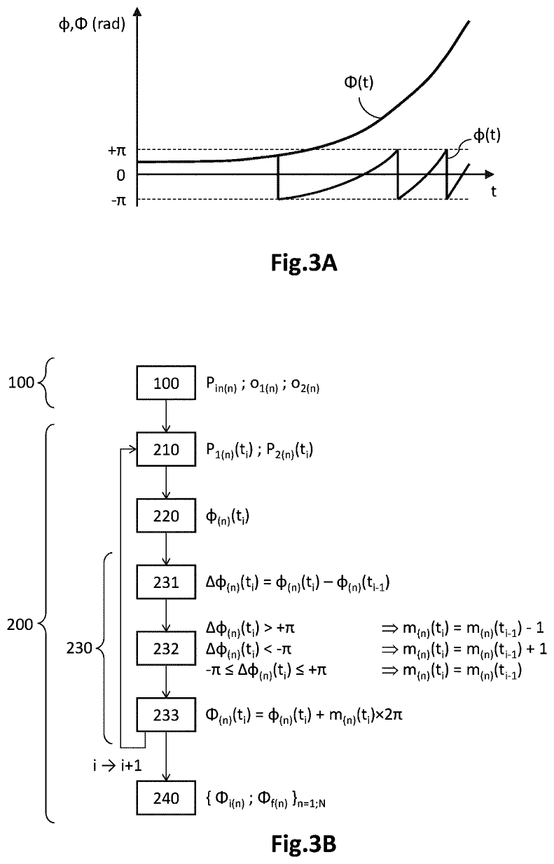

FIG. 3A exemplifies the time evolutions of the extracted phase shift Φ₍ₙ₎(t) and the unfolded phase shift Φ₍ₙ₎(t).

As previously mentioned, the power P₁(t) and P₂(t) of the optical signals output by a Mach-Zehnder interferometer 12 varies periodically, and more precisely sinusoidally, according to the phase shift between the optical signals passing through the arms of the interferometer 12. Since the phase extraction methods generally use an inverse trigonometric function such as an arctangent, the calculated phase shift then has values modulo 2π: this is then the extracted phase shift Φ(t).

Thus, as the analytes bind to the receptors 2 of a sensitive arm 14s, the phase shift increases between the optical signals passing through the two arms of the interferometer. Also, the extracted phase shift Φ(t) increases by exhibiting discontinuities of the order of 2π each time it reaches one of the bounds of an interval of width 2π, herein ]−π; +π]. Thus, it increases until it reaches +π, then exhibits a discontinuity of a value of −2π before dropping back down to the value of −π, and then resumes its growth. The unfolded phase shift Φ(t), which is representative of the effective phase shift between the optical signals passing through the interferometer arms, increases continuously without remaining contained within the interval ]−π; +π],

FIG. 3B exemplifies a flowchart of a process 200 for characterizing analytes by means of the calibrated characterization system 1 of FIG. 2A. The characterization process 200 follows a calibration process 100.

During the prior calibration process 100, which will be described in detail hereinafter, the values of the calibration parameters Param_{calib}, namely the input power Pᵢₙ₍ₙ₎ and the offsets o₁₍ₙ₎ and o₂₍ₙ₎, are determined for each of the Mach-Zehnder interferometers 12₍ₙ₎ of the measurement device 10, and stored in the processing unit 3. This process 100 is described in more detail hereunder, in connection with two different embodiments described hereinafter.

The characterization process 200 comprises a measurement step 210 of measuring, by the photodetectors 16, at each successive measurement instant tᵢ, the powers P₁₍ₙ₎(tᵢ) and P₂₍ₙ₎(tᵢ) of the optical signals transmitted by each of the interferometers 12 ₍ₙ₎. The measured values are transmitted to the processing unit 3. These powers P₁₍ₙ₎(tᵢ) and P₂₍ₙ₎(tᵢ) correspond to the optical signals transmitted by the two useful outputs 15u of each multimode coupler 15. This step is carried out during a reference phase Ph_{ref} in which the functionalized surface is not exposed to the analytes, and during a characterization phase Ph_{carac} in which it is exposed to the analytes.

In a step 220, the processing unit 3 determines the extracted phase shift Φ₍ₙ₎(tᵢ), from the calibration parameters Param_{calib}: Pᵢₙ₍ₙ₎, o₁₍ₙ₎ and o₂₍ₙ₎, and measured values of the optical power P₁₍ₙ₎(tᵢ) and P₂₍ₙ₎(tᵢ). This step can be carried out at each measurement instant tᵢ, as exemplified herein, or it can be carried out once the time evolution of the powers Pᵢ₍ₙ₎(tᵢ) and P₂₍ₙ₎(tᵢ) has been fully acquired.

For this purpose, knowing that the optical powers P₁₍ₙ₎(tᵢ) and P₂₍ₙ₎(tᵢ) can be expressed by the following equations:

$$\{ \begin{matrix}{P}_{1 ( n )} ( {ϕ}_{( n )} ( {t}_{i} ) ) = \frac{{P}_{i n ( n )}}{4} ( 1 + cos {Φ}_{( n )} ( {t}_{i} ) ) + {o}_{1 ( n )} \\ {P}_{2 ( n )} ( {ϕ}_{( n )} ( {t}_{i} ) ) = \frac{{P}_{i n ( n )}}{4} ( 1 - sin {Φ}_{( n )} ( {t}_{i} ) ) + {o}_{2 ( n )}\end{matrix}$$

the extracted phase shift Φ>(n)(ti) is deduced from the equation:

$${ϕ}_{( n )} ( {t}_{i} ) = arg ( x ( {t}_{i} ) - i \times y ( {t}_{i} ) ) \\ \text{with:} \\ \{ \begin{matrix}x ( {t}_{i} ) = {P}_{1 ( n )} ( {t}_{i} ) - {P}_{1 ( n )} / 4 - {o}_{1 ( n )} \\ y ( {t}_{i} ) = {P}_{2 ( n )} ( {t}_{i} ) - {P}_{1 ( n )} / 4 - {o}_{2 ( n )}\end{matrix}$$

wherein P₁₍ₙ₎(tᵢ) and P₂₍ₙ₎(tᵢ) are the values measured by the photodetectors 16, and wherein Pᵢₙ₍ₙ₎, o₁₍ₙ₎ and o₂₍ₙ₎ are the predetermined values of the calibration parameters Param_{calib} (which do not depend on tᵢ).

In a phase-unfolding step 230, the time evolution of the extracted phase shift Φ₍ₙ₎(tᵢ) is then corrected by adding a positive or negative integer multiple of the width 2π of the interval ]−π; +π], denoted m(tᵢ)×2π, wherein m(tᵢ) is a positive or negative integer. The latter is an increment that varies by one unit +1 or −1 at each discontinuity of the extracted phase shift Φ₍ₙ₎(tᵢ). This step is usually referred to as phase unfolding or phase unwrapping. This makes it possible to obtain the unfolded phase shift Φ₍ₙ₎, the values of which are no longer modulo 2π, and which is then effectively representative of the effective phase shift.

Different approaches are possible. In this example, an instantaneous variation ΔΦ₍ₙ₎(tᵢ)=Φ₍ₙ₎(tᵢ)−Φ₍ₙ₎(tᵢ₋₁) of the extracted phase shift Φ₍ₙ₎ between two successive measurement instants is calculated (sub-step 231), and then the increment m(tᵢ) is determined (sub-step 232). In this step, the value of this instantaneous variation ΔΦ₍ₙ₎(tᵢ) is compared with a predefined threshold value S1, for example with about n, so as to optionally add a positive or negative unit to the previous increment m(tᵢ₋ᵢ). Finally, the unfolded phase shift Φ₍ₙ₎(tᵢ) is determined (sub-step 233) by adding to the extracted phase shift Φ₍ₙ₎(tᵢ) the multiple of 2π, i.e. m(tᵢ)×2π.

Finally, in a characterization step 240, the processing unit 3 determines a stationary value Φᵢ₍ₙ₎ of the unfolded phase shift Φ₍ₙ₎(tᵢ), representative of the reference phase Ph_{ref} (absence of analytes), and a stationary value Φ_{f(n)} representative of the characterization phase Ph_{carac} (presence of analytes). The signature S of the analytes can then be determined, for example from the equation: S={Φ_{f(n)}−Φᵢ₍ₙ₎}_{n=1;N}.

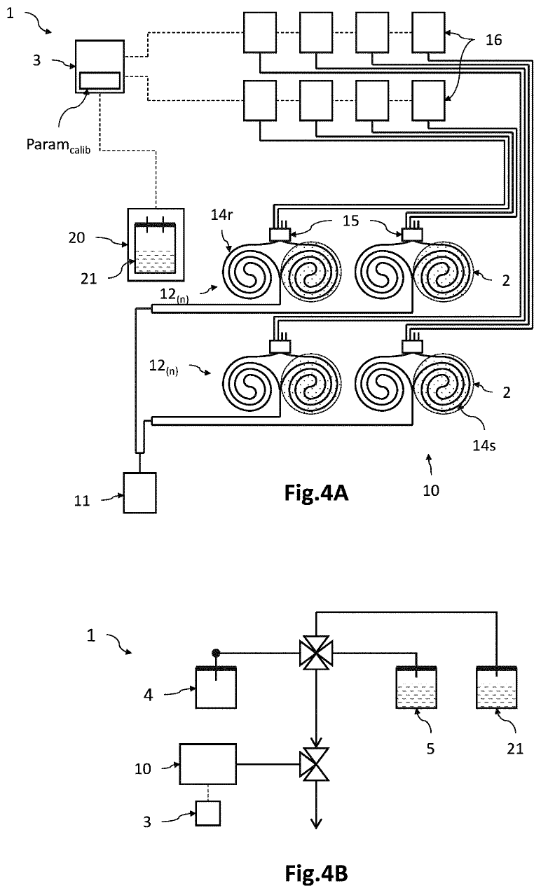

FIGS. 4A and 4B are schematic and partial views of a characterization system 1 to be calibrated, according to an alternative embodiment, in which the calibration device 20 comprises a reservoir of so-called calibration analytes 21, the concentration of which is suitable for causing a predefined minimum variation in the unfolded phase shift Φ₍ₙ₎(t).

The characterization system 1 comprises a measurement device 10 and a processing unit 3 identical to those of the characterization system 1 of FIG. 2A. It further comprises a calibration device 20, which, together with the processing unit 3, makes it possible to determine the values of the calibration parameters (power Pᵢₙ₍ₙ₎ and offsets o₁₍ₙ₎ and o₂₍ₙ₎) associated with each Mach-Zehnder interferometer 12₍ₙ₎.

The characterization system 1 can comprise a reservoir 4 of a reference fluid, comprising no analytes, this fluid being intended to be brought into contact with the functionalized surface during the reference phase. This may be a reservoir or controlled access to an analyte-free environment of the characterization system 1. It can also comprise a reservoir 5 for a fluid containing the analytes to be characterized, this fluid being intended to be brought into contact with the functionalized surface during the characterization phase. Herein too, it may be a reservoir or a controlled access to an environment with analytes of the characterization system 1. Finally, it comprises the reservoir 21 of a fluid containing calibration analytes.

Thus, during the previous calibration process 100, the calibration reservoir 21 is placed in fluid communication with the measurement device 10, and the fluid with the analytes is brought onto the functionalized surface. The analyte concentration has been predefined so that it causes a variation in the unfolded phase shift Φ₍ₙ₎(t) at least equal to a predefined minimum value ΔΦₘᵢₙ, which depends on the method used to determine the calibration parameters Pᵢₙ₍ₙ₎, o₁₍ₙ₎, and o₂₍ₙ₎.

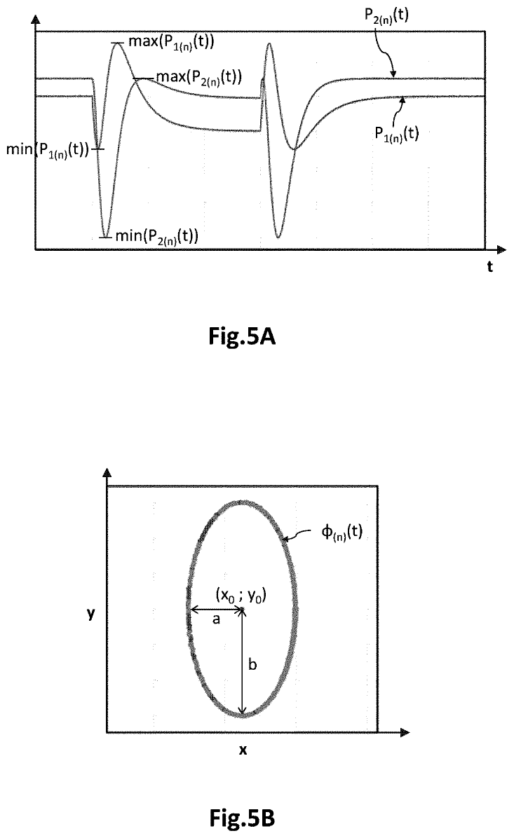

With reference to FIG. 5A, which exemplifies the time evolutions of the powers P₁₍ₙ₎ and P₂₍ₙ₎, the “min max” method, described in patent application EP21172910.8 filed on May 8, 2021, can be used. In this case, the minimum value Amin is preferably at least equal to 2π.

In this step, the functionalized surface is exposed to the calibration analytes, and the photodetectors 16 measure the power P₁₍ₙ₎ and P₂₍ₙ₎ of at least one interferometer (assuming that the calibration parameters Pᵢₙ₍ₙ₎, o₁₍ₙ₎, and o₂₍ₙ₎ are identical for all the interferometers 12), and preferably, as herein, of each of the interferometers 12₍ₙ₎. The calibration analytes therefore caused a variation of at least 2π in the unfolded phase shift Φ₍ₙ₎(t).

The minimum value min (P₁₍ₙ₎ (t)) which is equal to Pᵢ₍ₙ₎(Φ=π) and therefore to o₁₍ₙ₎ is measured, according to the definition of P₁₍ₙ₎(Φ) indicated previously. In addition, the maximum value max (P₁₍ₙ₎(t)) which is equal to P₁₍ₙ₎(Φ=0) and therefore to 2×(Pᵢₙ₍ₙ₎/4)+o₁₍ₙ₎ is measured. Pᵢₙ₍ₙ₎ can thus be deduced. The procedure is then performed on the time evolution of the optical power P₂₍ₙ₎(t), which makes it possible to deduce o₂₍ₙ₎, and thus to determine the values of the calibration parameters Param_{calib}, which are then stored in the processing unit 3. As can be seen, this method can also be used to determine Pᵢₙ₁₍ₙ₎ and Pᵢₙ₂₍ₙ₎ if these values were not equal for the two useful outputs 15u of the multimode coupler 15.

FIG. 5B exemplifies a time evolution of the extracted phase shift Φ₍ₙ₎(tᵢ) in the complex plane (x; y), wherein x and y are the previously defined parameters. This depiction is used as part of the ellipse method, described especially in the 2013 paper by Halir et al. mentioned hereinbefore. In this case, the minimum value ΔΦₘᵢₙ is advantageously equal to 2π, but it can be less than 2π if enough values have been acquired to be able to reconstruct a total ellipse by curve fitting.

The calibration parameters Param_{calib} can be deduced from the position and shape of the ellipse. Indeed, the half-length ‘a’ of the minor axis is equal to Pᵢₙₜ₍ₙ₎ and the half-length ‘b’ of the major axis is equal to Pᵢₙ₂₍ₙ₎. In addition, the coordinates (x₀; y₀) of the ellipse center make it possible to deduce the values of the offsets by the following equations: x₀=Pᵢₙ₁₍ₙ₎+o₁₍ₙ₎; y₀=Pᵢₙ₂₍ₙ₎+o₂₍ₙ₎.

Note that other methods for determining the calibration parameters can be used, such as for example solving a matrix system of equations like P=M×X, by optimization, wherein the observation matrix P contains the measured optical powers P₁₍ₙ₎ and P₂₍ₙ₎, the matrix M depends on the calibration parameters, and wherein the matrix X depends only on the phase shift Φ.

Also, this alternative embodiment in which the calibration device 20 comprises an analyte reservoir 21 keeps the footprint of the photonic chip small, since it does not comprise additional interferometer(s) and photodetectors. Once the values of the calibration parameters Param_{calib} have been defined and stored in the processing unit 3, the reservoir 21 of calibration analytes can be removed, resulting in a calibrated characterization system 1. Note that this reservoir 21 can be kept in the calibrated characterization system 1, for example in order to be able to periodically recalibrate the characterization system 1. Finally, it should be noted that this method enables the calibration parameters Param_{calib} to be accurately determined for each of the Mach-Zehnder interferometers 12₍ₙ₎.

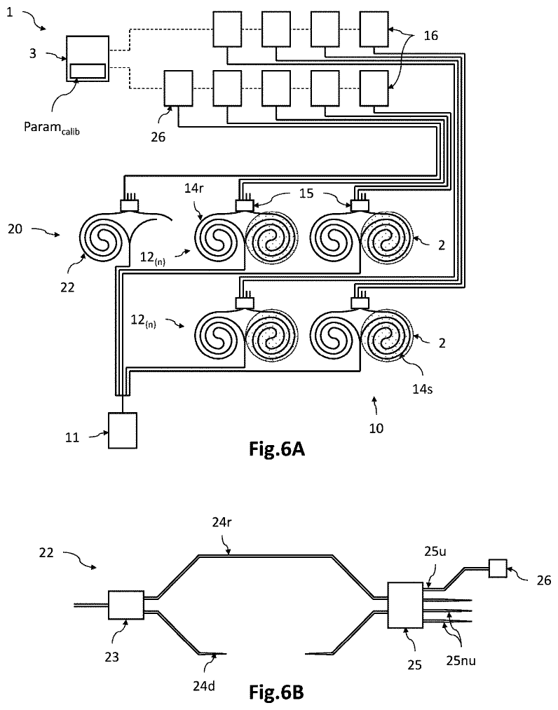

FIG. 6A is a schematic and partial view of a characterization system 1 to be calibrated, according to another alternative embodiment, in which the calibration device 20 comprises a Mach-Zehnder interferometer 22, referred to as calibration interferometer, associated with at least one calibration photodetector 26. FIG. 6B further exemplifies in greater detail the calibration interferometer 22 of the characterization system 1 of FIG. 6A.

The characterization system 1 herein comprises a measurement device 10 and a processing unit 3 identical to those of the characterization system 1 of FIG. 2A. It further comprises a calibration device 20, which, together with the processing unit 3, makes it possible to determine the values of the calibration parameters (power Pᵢₙ₍ₙ₎ and offsets o₁₍ₙ₎ and o₂₍ₙ₎) associated with each Mach-Zehnder interferometer 12₍ₙ₎.

The calibration interferometer 22 does not comprise a sensitive arm, and it is thus unaffected by the presence of analytes in the fluid medium. Its shape is preferably similar to that of the interferometers 12 of the measurement device 10. Thus, it may comprise two arms extending continuously between the input divider 13 and the multimode coupler 15 and optically independent of the external environment, or, as exemplified herein, a continuous arm 24r and a discontinuous arm 24d.

In this example in which the calibration interferometer 22 comprises a discontinuous arm 24d, the zone of the functionalized surface at this discontinuous arm 24d can have a notch similar to that of the interferometers 12 and intended to receive the analytes. In this zone, the analytes may still have been deposited. Alternatively, they may not have been deposited, but the notch may allow the external environment to have influenced the guided mode. For this reason, the waveguide 24d herein is discontinuous. When both the arms are continuous, the sheath is locally of sufficient thickness to avoid any influence of the external environment on the guided modes.

Furthermore, in this example, the outputs of the multimode coupler 25 each transmit an optical signal of power P_{in,calib}/2/4, i.e. P_{in,calib}/8. The four outputs of the multimode coupler 25 can each be coupled to a calibration photodetector. In order to avoid information redundancy, only one output (useful output 25u) of the multimode coupler 25 is coupled to the calibration photodetector 26.

The processing unit 3 is then able to determine at least one calibration parameter P_{in.calib} associated with this calibration interferometer 22, and can then define the parameters of the interferometers 12₍ₙ₎ of the measurement device 10.

Thus, in a first step of the calibration process 100, the offsets o₁₍ₙ₎ and o₂₍ₙ₎ of each interferometer 12₍ₙ₎ of the measurement device 10 are determined. For this purpose, while the light source 11 does not emit an optical signal, the photodetectors 16 of the measurement device 10 can measure optical power, which then corresponds to the offsets o₁₍ₙ₎ and o₂₍ₙ₎. Alternatively, it is possible to measure only the offset o_{calib} associated with the calibration photodetector 26 and to consider that the offsets o₁₍ₙ₎, o₂₍ₙ₎ of the photodetectors 16 of the measurement device 10 will be identical to the measured value o_{calib}.

Then, the light source 11 is activated to emit an optical signal. This second step of the calibration process 100 may be concomitant with the reference phase Ph_{ref} of the measurement step 210. The calibration photodetector 26 then measures the optical power P_{in,calib}/8 transmitted by the useful output 25u of the calibration interferometer 22. The processing unit 3 then determines the value Pᵢₙ₍ₙ₎ of each interferometer 12 ₍ₙ₎ of the measurement device 10 from the measured value P_{in, calib}/8.

Particular embodiments have just been described. Different variants and modifications will become apparent to a person skilled in the art.

1. A characterization system, suitable for characterizing analytes present in a fluid medium,
comprising a measurement device comprising:
at least one light source suitable for emitting an optical signal having predefined power;
an array of N Mach-Zehnder interferometers, with N>1, each comprising: an input divider coupled to the light source; two waveguides forming a sensitive arm, on the surface of which are located receivers with which the analytes are able to interact by adsorption/desorption, and a reference arm; and a multimode output coupler, coupled to the two waveguides;
an array of photodetectors, suitable for measuring the powers of the optical signals transmitted by the multimode couplers;
and a processing unit, suitable for determining, for each Mach-Zehnder interferometer of index n ranging from 1 to N: a phase shift Φ(n) (t) between the optical signals circulating in the waveguides, from the measured powers; values Φᵢ₍ₙ₎ and Φ_{f(n)}, from the phase shift Φ₍ₙ₎(t), associated with a reference phase in which the analytes are not present and a characterization phase in which the analytes are present and interact with the receptors, respectively; and then for characterizing the analytes, from the values Φᵢ₍ₙ₎ and Φ_{f(n)};
wherein:
each of the multimode couplers has a plurality of outputs, only two of which, referred to as useful outputs, phase-shifted by π/2, are coupled to the photodetectors;
the photodetectors form an array of 2×N photodetectors, each measuring the powers P₁₍ₙ₎(t) and P₂₍ₙ₎(t) of the optical signals transmitted by the useful outputs of each Mach-Zehnder interferometer;
the processing unit comprises, for each of the Mach-Zehnder interferometers, predetermined values of calibration parameters consisting of: an input power Pᵢₙ₍ₙ₎ of the optical signal incident on the input divider, according to the predefined power of the optical signal emitted by the light source; and optical power offsets o₁₍ₙ₎, o₂₍ₙ₎ associated with each useful output and defined when the light source is inactive;
the processing unit is suitable for determining the phase shift Φ₍ₙ₎(t) from the optical powers P₁₍ₙ₎(t) and P₂₍ₙ₎(t) measured and associated with the useful outputs, and predetermined values of the calibration parameters Pᵢₙ₍ₙ₎, o₁₍ₙ₎, and o₂₍ₙ₎.

2. The characterization system according to claim 1, wherein each output coupler comprises outputs not coupled to the array of photodetectors, referred to as “non-useful” outputs, comprising tapered ends.

3. The characterization system according to claim 1, comprising a photonic chip containing: the array of N Mach-Zehnder interferometers as well as an array of 2×N optical detection elements coupled to the N interferometers by integrated waveguides, the optical detection elements being either said photodetectors or diffraction gratings coupled to an array photodetector.

4. The characterization system, wherein the measurement device comprises an array of at least four Mach-Zehnder interferometers.

5. The characterization system according to claim 1, wherein each multimode coupler is a 2×4 coupler.

6. The characterization system according to claim 1, comprising a calibration device suitable for determining, with the processing unit, the values of the calibration parameters Pᵢₙ₍ₙ₎, o₁₍ₙ₎, and o₂₍ₙ₎.

7. The characterization system according to claim 6, wherein the calibration device comprises a reservoir of so-called calibration analytes, placed in fluid communication with the measurement device to allow the calibration analytes to interact with the receptors, with a predefined concentration of calibration analytes to induce, when interacting with the receptors, a predefined minimum variation ΔΦₘᵢₙ of the phase shift Φ₍ₙ₎(t) of each of the Mach-Zehnder interferometers.

8. The characterization system according to claim 6, wherein the calibration device comprises a Mach-Zehnder interferometer, referred to as calibration interferometer, coupled to at least one so-called calibration photodetector.

9. The characterization system according to claim 8, wherein the calibration interferometer comprises a reference arm and a discontinuous arm.

10. The process for calibrating a characterization system according to claim 7, comprising the following steps:
activating the light source to emit the optical signal at the predefined power;
placing the calibration analytes in contact with the receptors;
measuring, by means of the photodetectors, a power P₁₍ₙ₎(t), P₂₍ₙ₎(t) of the optical signals transmitted by each Mach-Zehnder interferometer, while the calibration analytes interact with the receptors and induce a variation of the phase shift Φ₍ₙ₎(t) that is at least equal to the predefined minimum value ΔΦₘᵢₙ;
determining, by means of the processing unit, the values of the calibration parameters Pᵢₙ₍ₙ₎, o₁₍ₙ₎, and o₂₍ₙ₎ from the measured powers P₁₍ₙ₎(t), P₂₍ₙ₎(t), and storing in the processing unit the determined values of the calibration parameters Pᵢₙ₍ₙ₎, o₁₍ₙ₎, and o₂₍ₙ₎.

11. The calibration process according to claim 10, wherein the calibration parameters Pᵢₙ₍ₙ₎, o₁₍ₙ₎, and o₂₍ₙ₎ are determined from the minimum and maximum values of the measured powers P₁₍ₙ₎(t), P₂₍ₙ₎(t).

12. The process for calibrating a characterization system according to claim 8, comprising the following step:
measuring, by means of the calibration photodetector, the power of the optical signal transmitted by the calibration interferometer, while the light source is activated;
determining a value for the input power P_{in,calib} of the optical signal incident on an input divider of the calibration interferometer; then
determining the input value Pᵢₙ₍ₙ₎ for each of the interferometers in the measurement device from the determined value P_{in,calib}.

13. The calibration process according to claim 12, comprising the following steps:
measuring a power Pᵢ₍ₙ₎(t), P₂₍ₙ₎(t) of the optical signals transmitted by each interferometer of the measurement device, by the photodetectors of the measurement device, while the light source is inactive; then
determining the offset values o₁₍ₙ₎ and o₂₍ₙ₎ from the measured powers P₁₍ₙ₎(t), P₂₍ₙ₎(t).

14. The process for characterizing analytes by a characterization system according to claim 1, comprising the following steps:
measuring, by means of the photodetectors of the measurement device, a power P₁₍ₙ₎(t), P₂₍ₙ₎(t) of the optical signals transmitted by each Mach-Zehnder interferometer, during a reference phase in which the analytes are not present, and during a characterization phase in which the analytes are present and interact with the receptors;
determining, by means of the processing unit, for each Mach-Zehnder interferometer, the phase shift Φ₍ₙ₎(t) between the optical signals circulating in the arms, from the measured powers P₁₍ₙ₎(t), P₂₍ₙ₎(t) and the predetermined values of the calibration parameters Pᵢₙ₍ₙ₎, o₁₍ₙ₎, and o₂₍ₙ₎;
determining values Φᵢ₍ₙ₎ and Φ_{f(n)} from the phase shift Φ₍ₙ₎(t), associated with the reference phase and the characterization phase, respectively;
characterizing the analytes from the values Φᵢ₍ₙ₎ and Φ_{f(n)}.

15. The characterization process according to claim 14, wherein the step of determining the phase shift Φ₍ₙ₎(t) consists in determining:
a phase shift Φ₍ₙ₎(t), referred to as extracted phase shift, the values of which are between 0 and 2π, from the measured powers P₁₍ₙ₎(t), P₂₍ₙ₎(t) and the predetermined values of the calibration parameters Pᵢₙ₍ₙ₎, o_{1 (n)}, and o₂₍ₙ₎; then
the phase shift Φ₍ₙ₎(t), referred to as unfolded phase shift, by unfolding the extracted phase shift Φ₍ₙ₎(t) by adding a positive or negative integer multiple of 2× thereto.
